(19) United States
(12) Patent Application Publication
(10) Pub. No.: US 2003/0145221 A1
(43) Pub. Date: Jul. 31, 2003

(54) Smart cards for the authentication in machine controls

(76) Inventors: Clemens Atzmueller, Gemuenden (DE); Werner Mueller, Lohr am Main (DE)

Correspondence Address: Striker Striker & Stenby, 103 East Neck Road, Huntington, NY, 11743, US

(21) Appl. No.: 10/276,189

(22) PCT Filed: May 21, 2001
(86) PCT No.: PCT/DE01/01906

(30) Foreign Application Priority Data
Nov. 13, 2002 (DE) 100 25 791.7

(51) Int. Cl. G06F 17/00

(52) U.S. Cl. 713/200; 235/375; 340/5.65

(57) ABSTRACT

The invention relates to an efficient and interference insensitive authentication test procedure for accessing a machine control (1). Said procedure is carried out through reading and checking of cards (10-12) in a centralised control system and/or in decentralised control systems.

The invention relates to a method and a control unit for authentication testing for access to a machine control unit, in particular of a machine tool control unit, a printing press control unit, or the like.

In-house prior art proprietary to the applicant has disclosed embodying an authentication, for example using conventional (mechanical) keys or code words.

The object of the invention is to produce a method and a control unit, which, in a remote machine control unit, permit an authentication testing that is as simple, efficient, and malfunction-free as possible. This is attained by means of the subjects of the independent claims.

An authentication testing by means of cards, in particular smart cards, permits an efficient, system-wide, updated matching of data relating to authenticated cards, degrees of access authorization (definition=what the user of a card is authorized to access), possibly codes requested in addition to a card, etc. by means of a connection, for example networks, between remote control units and a central control unit.

The authentication can be executed solely based on a card, or alternatively by means of additionally requesting a code word.

If reading devices are provided in remote control units, then a file containing data that represent access-authorized cards is suitably stored in these remote control units. This makes it possible, in the event of an interruption in the connection between the remote control units and/or a central control unit, for there to be an authentication testing on the part of the remote control unit by reading a card there and authentication testing there based on data stored in the remote control unit until the connection is reestablished.

In the context of the claims, cards can be embodied in a wide variety of forms. These can be intelligent smart cards or passive cards that can be read, for example optically, electronically, or magnetically.

A central control unit in the context of the application is not necessarily a main control unit in the control engineering sense; it can also be a PC, which is situated in an office workstation and/or can be reached via a network, etc. by all of the remote control PCs. The remote control unit can, in particular, be a control unit in an element/element group to be controlled.

Other features and advantages of the invention ensue from the claims and the following description of an exemplary embodiment in conjunction with the drawing.

The sole figure shows a block circuit diagram of an authentication system according to the invention.

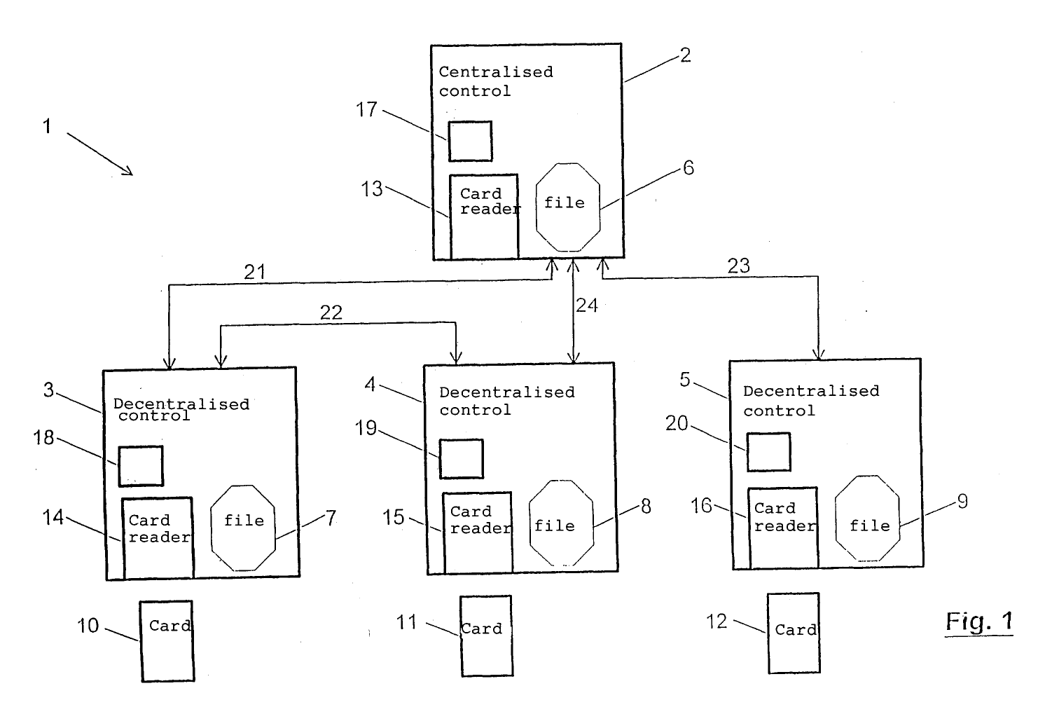

FIG. 1 shows a machine control unit 1 with a central control unit 2 and remote control units 3 to 5. The central control unit (and, in the current instance, the remote control units 3 to 5) contain files 6 (as well as 7, 8, 9) stored in a memory, which files contain data relating to access-authorized cards, i.e. identity data that can be read from the cards in an arbitrary fashion, and contain a list of the rights permitted for each card. All of the cards 10 to 12 can be provided with the same access authorizations, or there can be different access authorizations for several cards (for example for the machine adjuster and installer). Schematically depicted card reader devices 13, 14 to 16 are provided in the central control unit 2 and/or the remote control units 3 to 5; these card readers can read cards 10 to 12 inserted into them (or alternatively can read cards via radio).

A comparison unit compares the data, which can be read from cards in an arbitrary fashion, to stored data relating to access-authorized cards (files 6, 7 to 9), and the user of a card is permitted access only to the degree stored for this card in a file 6, 7 to 9. The comparison units 17, 18 to 20 can be disposed in a central control unit and/or in remote control units. If in addition to a card reader, the remote control units are also provided with a remote comparison unit 18 to 20, then an authentication test can be performed autarkically in the remote control unit 3; as a result, it is possible for authentication testing to be performed in the remote control unit even if there is a break in the connection 21, 22, 23, 24 between the remote units and/or between remote units and a central unit (e.g. in the form of a network, field bus, etc.). This also permits work and/or maintenance and/or installation, etc. to be performed on a remote unit even if the connection is broken due to a malfunction.

1. A method for authentication testing for access to a machine control unit, in particular of a machine tool control unit, a printing press control unit, or the like, in which the authentication testing takes place through the reading and testing of a card (10 to 12), characterized in that there are several different degrees of access authorization, which permit different actions in a control unit, where the degrees of access authorization are stored on the card or in a file (6 to 9).

2. The method according to claim 1, characterized in that the testing of a card (10 to 12) takes place in a remote control unit (3 to 5).

3. The method according to claim 1 or 2, characterized in that the machine control unit (1) includes a central control unit (2) and remote control units (3 to 5), which are connected (21 to 23) to the central control unit and/or to remote control units, and that an authentication test can be carried out by reading a card at a remote control unit (3 to 5).

4. The method according to claim 3, characterized in that the testing of a card takes place by comparing data read from a card to data that are stored in the remote control unit (3 to 5) and relate to access-authorized cards (10 to 12).

5. The method according to one of the preceding claims, characterized in that a card is a smart card, in particular an intelligent smart card and/or a card with a memory.

6. The method according to one of the preceding claims, characterized in that a card is one, which can be read magnetically, optically, or electronically.

7. The method according to one of the preceding claims, characterized in that a file, which is stored in a remote control unit (18 to 20) and contains data relating to access-authorized cards, is matched to a file (6) stored in the central control unit at regular intervals and/or when changes are made to a file.

8. The method according to one of the preceding claims, characterized in that in the event of an interruption in the connection (21 to 24) of a remote control unit (3) to the central control unit (2) or to another remote control unit (4, 5), until the connection (21 to 24) is reestablished, the remote control unit (3) continues to perform an authentication testing based on the last data (7) stored in it before the connection was broken.

9. The method according to one of the preceding claims, characterized in that the authentication testing of a card also includes the fact that a code word is requested from the user of the card.

10. The method according to one of claims 1 to 8, characterized in that no code word is requested in the authentication testing of a card.

11. A control unit for executing the method according to one of the preceding claims.

12. A control unit (1) in particular according to claim 11 for authentication testing for access to a machine control unit (1),
with remote control units (3 to 5), which are connected to a central control unit (2) and/or to remote control units (3 to 5),
with card reading devices for reading cards for authentication testing,
with at least one memory (6, 7 to 9), in which data related to access-authorized cards (10 to 12) are stored,
with a comparison device (17, 18 to 20) for authentication testing by comparing the data stored in a memory (6, 7 to 9) to data read from a card (10 to 12).

13. The control unit according to claim 12, characterized in that reader devices (14 to 16) are provided in remote control units (3 to 5).

14. The control unit according to one of claims 12 or 13, characterized in that data relating to access-authorized cards (10 to 12) are stored at least in remote control units (18 to 20).

15. The control unit according to one of claims 12 to 14, characterized in that it is designed so that a matching between the files (7 to 9) stored in the remote control units (3 to 5) and a file (6) stored in a central control unit (2) is carried out cyclically and/or when a change is made to data in a file (6, 7 to 9).

16. The control unit according to one of claims 12 to 15, characterized in that the remote control units (3 to 5) are designed so that in the event of an interruption in the connection (21 to 24) to a central control unit (2) and/or to remote control units (4, 5), they continue to perform authentication tests based on data (7) stored in the remote control unit (3) until the connection (21 to 24) is reestablished.
